(19) United States
(12) Patent Application Publication
(10) Pub. No.: US 2011/0073408 A1
(43) Pub. Date: Mar. 31, 2011

(54) LIFELINE SUPPORT RAIL

(76) Inventor: Jan Vetesnik, Winnipeg (CA)

(21) Appl. No.: 12/566,838

(22) Filed: Sep. 25, 2009

(51) Int. Cl. E06C 7/18; A62B 35/00; A62B 35/04; E04G 21/32

(52) U.S. Cl. 182/3; 182/36

(57) ABSTRACT

A life line support for the traveler of a safety harness includes an elongate flexible tensioned cable and a square tube loosely surrounding the cable defining an outside surface for receiving the traveler for movement along the tube. The traveler includes rollers and is formed in two parts which can open to engage around the tube from one side and held closed by the attachment of the life line. The tube is tensioned between wall mountings and the cable is tensioned relative to the wall mountings by additional springs pulling on the cable separately from the tube. The cable thus provides the support strength while the tube provides the rolling surface.

This invention relates to an elongate support for carrying a longitudinally moveable traveller such as a support rail for a life line.

Safety harnesses for person working at a height include the harness, a lifeline and a shock absorber. These need to attach to a suitable structural member which allows the line to move with the person to different locations while remaining attached. This is typically a simple stretched cable which can be oriented horizontal or vertical depending on the direction of movement of the person if vertical suitable locking devices are provided to halt sliding in the event of a fall.

### SUMMARY OF THE INVENTION

It is one object of the present invention to provide an improvement over and option to standard cable-based horizontal and vertical lifeline fall protection system.

According to the invention there is provided an elongate support for allowing longitudinal movement of a traveler element along the support comprising:

an elongate flexible cable extending continuously along the support;

a pair of attachment members for holding respective ends of the cable so as to maintain the cable supported and tensioned along its length;

and a tube surrounding the cable and extending along the length of the support;

the tube having an inside surface loosely received on and separate from an outside surface of the cable;

the tube defining an outside surface for receiving the traveler element thereon for movement along the tube.

Preferably the tube is non-circular in cross-section so as to define flat surfaces and apexes along its length.

Preferably the traveler element is arranged to run on the flat surfaces.

Preferably the tube is substantially square in cross-section so as to define flat surfaces and apexes along its length.

Preferably the tube is supported by support elements at spaced positions along its length so that the tube is partly supported by the cable and partly by the support elements, and wherein the traveler element is arranged to pass the support elements.

Preferably the support elements each include a flange which is attached along the tube and a mounting plate at an outer end of the flange which can be fastened to a support surface.

Preferably in one type of bracket the mounting plate is at a fixed angle to the flange.

Preferably in another type of bracket the mounting plate can swivel relative to the flange about an axis parallel to the cable.

Preferably the cable is tensioned longitudinally and wherein the tube is tensioned separately from the cable.

Preferably the tube is tensioned by a holding bracket attached to the end of the tube and the cable is tensioned by springs arranged to apply a spring force relative to the holding bracket.

Preferably there is provided a cable end clamp on the end of the cable.

Preferably the holding bracket includes a sleeve surrounding the cable end.

Preferably the tube is formed in jointed pieces connected longitudinally.

Preferably the jointed pieces are connected by inserted tube portions at joints along the tube.

Preferably the traveler element engages around tube and the traveler element has a slot to pass over the flanges.

Preferably the traveler element has rollers for rolling along the outside surface of the tube.

Preferably the traveler element includes two hinged pieces which can open to release the tube.

Preferably the two hinged pieces of the traveler element define a mounting receptacle for a coupling of a safety support harness.

Preferably the two hinged pieces of the traveler element are held in the closed position when the coupling is engaged in the mounting receptacle.

The cable can horizontal or the cable can be non-horizontal in which case the traveler element includes a brake to engage the tube to prevent uncontrolled movement of the traveler element along the tube and to halt movement in the event of a fall.

Preferably the tube is arranged to be deformed by forces on the tube from the traveler element beyond a predetermine maximum.

According to a second aspect of the invention there is provided a fall arrest system comprising a harness; a support line of the harness; a traveller element for connection to the support line and a support as defined above for connection to the traveller element to allow longitudinal movement of the support line.

Thus the design uses a cable routed through the interior of a relatively small square tube. The strength required for such an application is derived from the interior cable, while the exterior tube provides a consistent and uniform surface upon which the traveler can run. The exterior tube also provides a convenient, consistent, and easy-to orient surface to which mounting brackets may be attached.

The use of the tube also adds an element of strength so as to reduce the inherent sag found in all horizontally installed cable lifeline systems that objectionably increases required clearance allowance below the installed system. Less initial sag reduces required clearance allowance, and allows for installation in situations where site geometry limits available clearance.

### BRIEF DESCRIPTION OF THE DRAWINGS

One embodiment of the invention will now be described in conjunction with the accompanying drawings in which:

FIG. 1 is an isometric view of a support and traveller according to the present invention for supporting a lifeline and harness of a conventional nature shown schematically.

FIG. 2 is a cross sectional view of the cable and tube structure of the support of FIG. 1.

FIG. 3 is a top plan view of one end of the support of FIG. 1.

FIG. 4 is a cross sectional view along the lines A-A of FIG. 3.

FIG. 5 is an isometric view of the traveller of FIG. 1.

FIG. 6 is a front elevational view of the traveller of FIG. 1.

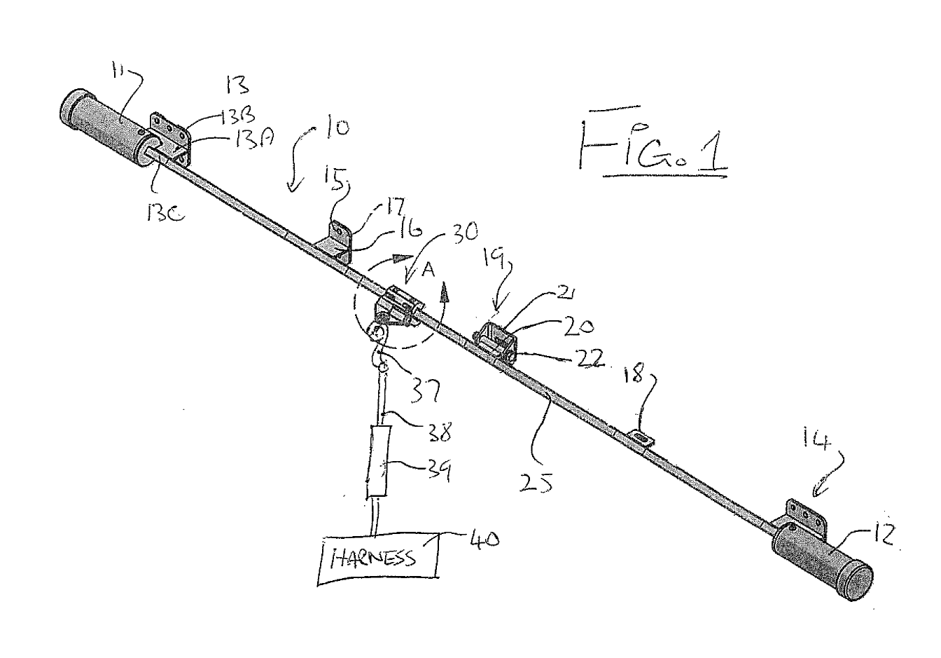

In the drawings like characters of reference indicate corresponding parts in the different figures.

### DETAILED DESCRIPTION

An elongate support 10 which can be arranged horizontally or at an other angle including vertically is arranged to carry a traveler 30 for movement along the support which in turn carries a coupling 37 of a life line 38 of a conventional harness 40. Such harnesses for fall protection are well known and thus not described in detail, but include a fall arrest system 39 to contain the shock loading allowing the support and life line to hold the wearer against falling to the ground.

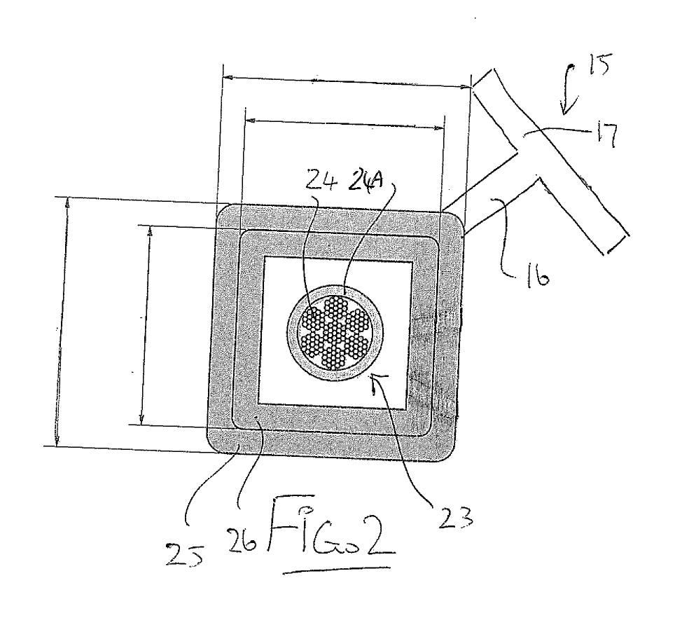

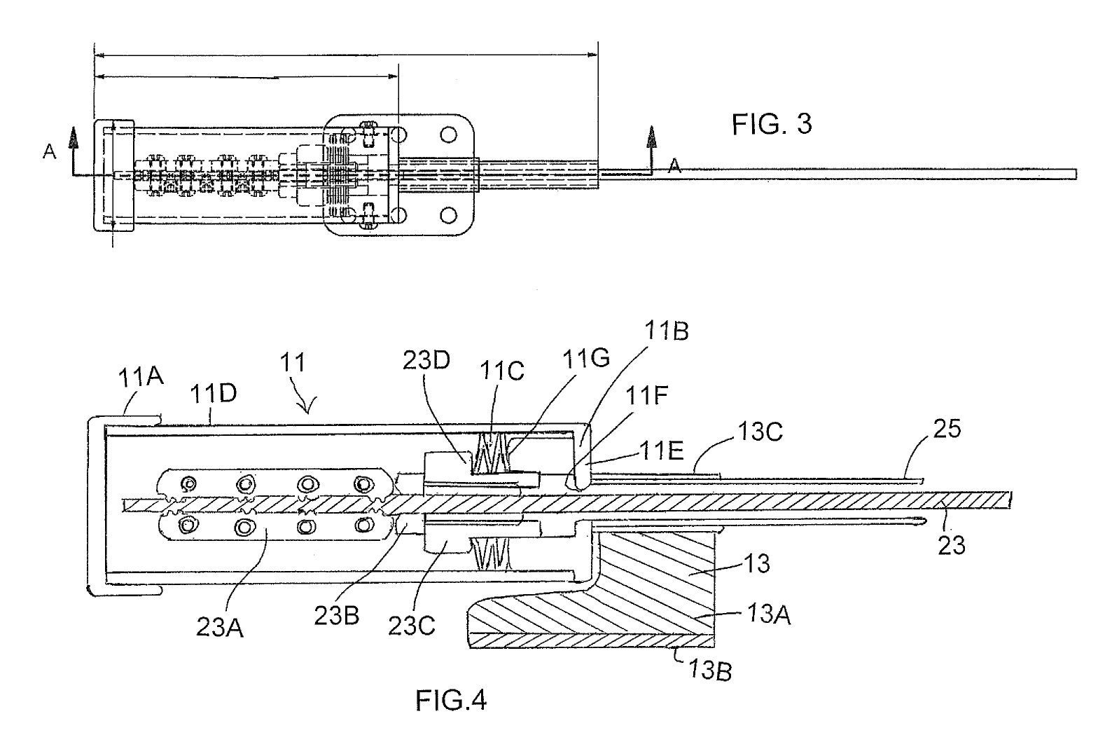

The support 10 includes a cable 23 inside a tube 25. The tube 25 has an inside surface loosely received on and separate from the outside surface of the cable. The tube 25 defines an outside surface for receiving the traveler element thereon for movement along the tube. As shown in FIG. 2, the cable is a typical steel cable having a plurality of bundles of strands 24 contained within an optional wrapping sleeve 24A typically of a plastics material. The cable has a circular outer surface. The tube 25 is formed in tube pieces each part of the length of the support and connected by joining pieces 26 which slide inside the tube 25 at ends of the tube to be connected as a sliding fit and are adhesively attached to the tube to hold the tube pieces end to end as a longitudinally continuous tube structure.

The tube is non-circular in cross-section so as to define flat faces and corners or apexes connecting the flat faces. Typically this will be square but other polygonal shapes can be used.

The inside surface of the tube thus defined by the inside of the tube pieces or the joining pieces 26 is thus square and is dimensioned so that it is larger than the outside diameter of the cable. Thus the cable is a loose fit within the tube and can move side to side within the tube. However the cable provides the main structural support for the support as a whole so that the tube rests at one point of its inside surface on the cable. The tube can therefore easily be applied over the cable and is not part of the cable or a tight fit over the outside surface of the cable.

The support 10 defined by the cable 23 and the tube 25 is attached to end couplings 11 and 12 attached to the end of the tube and the cable and each mounted on end holding brackets 13 and 14. Each holding bracket is attached to a wall or the like by a flange 13A and a mounting plane 13B at right angles to the flange 13A so that the flange stands outwardly from the wall and holds the support at a spacing from the wall.

The tube 25 is also attached to the wall at spaced positions along its length by support brackets 15, 18 and 19. The number and type of bracket selected depends on the surface to which it is to be attached and the total length of the support 10. Bracket 15 is of a simple fixed type with a flange 16 and a right angle mounting plate 17 for screw fastening to the wall. The flange 16 is attached to one corner of the square profile of the tube and extends longitudinally along the tube at that corner. The plate 17 is spaced away from the tube at the outer end of the flange 16.

Bracket 18 is also of a fixed type which is formed simply by a flange along the corner of the tube where the flange itself is screw fastened to a surface.

Bracket 19 is of a swivel type where a base plate 21 is fastened to a surface and the flange 20 is connected to a swivel 22 carried on the base plate 21 and pivotal relative to the base plate at a pivot axis at the outer edge of the flange 20 and parallel to the cable and to the surface to which the base plate 21 is attached. This allows the tube to swivel about an axis parallel to the tube as required if the surface to which the tube is fastened is not itself fixed.

As shown in FIG. 4, the bracket 13 carries at the inner end of the flange 13A a support sleeve 13C into which the end of the tube 25 is inserted so as to hold the end of the tube at a fixed position. The sleeve 13C is adhesively fastened to the outside of the tube 25 so that the bracket 13 and 14 can be used to provide a longitudinal tension on the tube 25 to prevent it from sagging. This tendency to sag over long lengths is further reduced by the provision of the support brackets 15, 18 and 19 as required at spaced positions between the ends of the tube. The sleeve 13C is attached to or butts the end holding bracket 11 which carries the end of the cable 23. The bracket 11 includes a sleeve 11D with an end cap 11B at one end and end cap 11A at the other end. The end cap 11B butts the tube 13C so that longitudinal tension from the cable is communicated through the end cap 11B to the tube 13C and the bracket 13 to the mounting surface to which the support is attached. The end cap 11B includes an end face plate 11E and a bore 11F through which the cable 23 passes. The cable is attached to an end clamp 23 which includes a screw clamp portion 23A engaged around the cable end which butts against a ferrule defined by portions 23B and 23C surrounding the cable. The ferrule includes an outer surface which is a sliding fit inside the bore 11F of the end cap 11B so as to locate the cable end coaxial to the end of the tube 25 at the sleeve 13C. The ferrule 23C includes a shoulder 23D surrounding the cable which cooperates with an end face 11G of the end cap 11B to locate springs 110. The springs are selected to provide a longitudinal tension to the cable which is thus separate from and greater than the tension applied to the tube. The springs apply sufficient tension to ensure that the cable provides the majority of the support for the tube and prevents major distortion or collapse of the tube under loading from a fall.

It will be appreciated however that the sag of the cable will be different from the sag of the tube, bearing in mind that the tube is also supported periodically by brackets so that the cable is only co-axial to the tube at the ends and in between will engage the tube at one part of its inner surface to provide support for the tube.

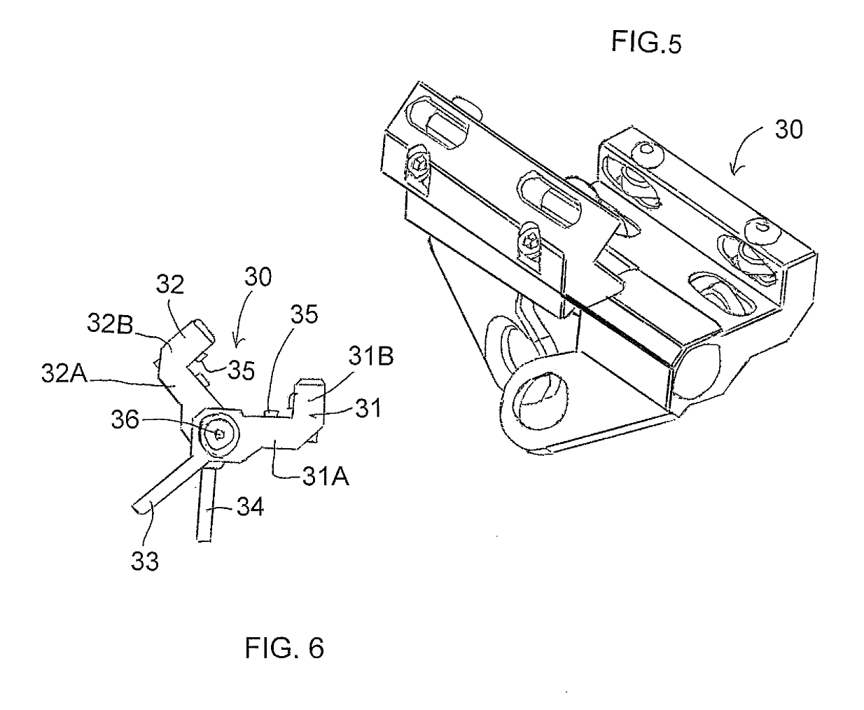

As shown in FIGS. 5 and 6, the traveler element 30 engages around tube and has a slot to pass over the flanges of the various support brackets of the tube. The traveler element has rollers 35 for rolling along the flat portions of the outside surface of the tube. The traveler element includes two hinged pieces 31 and 32 which can open to release the tube.

The two hinged pieces of the traveler element include arms 33, 34 with openings which, when closed define a mounting receptacle for the coupling 37 of the safety support harness 40. The two hinged pieces of the traveler element are held in the closed position when the coupling 37 is engaged in the mounting receptacle defined by the arms 33 and 34. Each of the pieces 31 and 32 includes a pair of right angle members 31A and 31B, 32A and 32B, each when the traveler is in the closed position, for cooperating with a respective one of the flat surfaces of the tube in a rolling action provided by the rollers 35 carried on those members 31A, 31B, 32A and 32B. At the junction between the members 31B and 32B is provide the slot to pass over the flanges such as the flange 16 of FIG. 2.

The tube is arranged to be deformed by forces on the tube from the traveler element beyond a predetermined maximum. In this way the damage caused by the shock loading of a fall is readily visible and apparent this requiring that part of the tube to be identified and replaced.

The drawings as shown use for example a 3/16″ 7×19 galvanized steel aircraft cable, PVC coated, run through ⅝″ square 0.065 wall stainless steel tube. The sections of the ⅝″ tubing are sleeved together at their connection points using relatively short lengths of 0.5 inch square 0.065 wall stainless tubes, and are retained with an adhesive or other means. However this is merely exemplary.

The cable is tensioned inside the tubes using the tensioning device shown to hold the assembled lifeline together, and the tube itself is then tensioned to pre-load and align the system.

The system is designed to come apart if required to replace any section damaged by an impact loading. The deformation of the exterior tube will provide a visual indicator of any impact loading, not always readily observable in straight cable designs.

The mobile anchor point (traveler, shuttle, trolley) is designed to open by sliding the two halves of the assembly away from each other, and rotating to disengage the wheels from the track. By inserting the connector for a personal fall arrest system (double-locking snap, carabiner, or otherwise) through the eye plates once they are aligned, the assembly is prevented from disengaging the track with a worker attached. The two halves of the assembly may or may not be spring loaded to bias the assembly to a closed position.

The system may be installed horizontally (either to a wall, ceiling, or floor) using the non-locking mobile anchor point design shown in the drawings, or inclined up to 90 degrees using a variation of the mobile anchor point incorporating a locking mechanism (not shown).

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An elongate support for allowing longitudinal movement of a traveler element along the support comprising:
an elongate flexible cable extending continuously along the support;
a pair of attachment members for holding respective ends of the cable so as to maintain the cable supported and tensioned along its length;
and a tube surrounding the cable and extending along the length of the support;
the tube having an inside surface loosely received on and separate from an outside surface of the cable;
the tube defining an outside surface for receiving the traveler element thereon for movement along the tube.

2. The support according to claim 1 wherein the tube is non-circular in cross-section so as to define flat surfaces and apexes along its length.

3. The support according to claim 2 wherein the traveler element is arranged to run on the flat surfaces.

4. The support according to claim 3 wherein the tube is substantially square in cross-section so as to define flat surfaces and apexes along its length.

5. The support according to claim 1 wherein the tube is supported by support elements at spaced positions along its length so that the tube is partly supported by the cable and partly by the support elements, and wherein the traveler element is arranged to pass the support elements.

6. The support according to claim 5 wherein the support elements each include a flange which is attached along the tube and a mounting plate at an outer end of the flange which can be fastened to a support surface.

7. The support according to claim 6 wherein the mounting plate is at a fixed angle to the flange.

8. The support according to claim 6 wherein the mounting plate can swivel relative to the flange about an axis parallel to the cable.

9. The support according to claim 1 wherein the cable is tensioned longitudinally and wherein the tube is tensioned separately from the cable.

10. The support according to claim 9 wherein the tube is tensioned by a holding bracket attached to the end of the tube and the cable is tensioned by springs arranged to apply a spring force relative to the holding bracket.

11. The support according to claim 10 wherein there is provided a cable end clamp on the end of the cable.

12. The support according to claim 10 wherein the holding bracket includes a sleeve surrounding the cable end.

13. The support according to claim 1 wherein the tube is formed in jointed pieces connected longitudinally.

14. The support according to claim 13 wherein the jointed pieces are connected by inserted tube portions at joints along the tube.

15. The support according to claim 1 wherein the traveler element engages around tube and the traveler element has a slot to pass over the flanges.

16. The support according to claim 1 wherein the traveler element has rollers for rolling along the outside surface of the tube.

17. The support according to claim 1 wherein the traveler element includes two hinged pieces which can open to release the tube.

18. The support according to claim 17 wherein the two hinged pieces of the traveler element define a mounting receptacle for a coupling of a safety support harness.

19. The support according to claim 17 wherein the two hinged pieces of the traveler element are held in the closed position when the coupling is engaged in the mounting receptacle.

20. The support according to claim 1 wherein the cable is horizontal.

21. The support according to claim 1 wherein the cable is non-horizontal and the traveler element includes a brake to engage the tube to prevent uncontrolled movement of the traveler element along the tube and to halt movement in the event of a fall.

22. The support according to claim 1 wherein the tube is arranged to be deformed by forces on the tube from the traveler element beyond a predetermine maximum.

23. A fall arrest system comprising:
a harness;
a support line of the harness;
a traveller element for connection to the support line;
and a support according to any preceding claim for connection to the traveller element to allow longitudinal movement of the support line.
